(19) United States
(12) Patent Application Publication
(10) Pub. No.: US 2010/0132199 A1
(43) Pub. Date: Jun. 3, 2010

(54) CUTTING KNIFE

(76) Inventor: Lein-Shan Ruan, Guangdong (CN)

Correspondence Address: PATTERSON & SHERIDAN, L.L.P., 3040 POST OAK BOULEVARD, SUITE 1500, HOUSTON, TX, 77056, US

(21) Appl. No.: 12/570,967

(22) Filed: Sep. 30, 2009

(30) Foreign Application Priority Data
Nov. 29, 2008 (CN) 200830220861.6

(51) Int. Cl. B26B 1/08; B26B 1/10

(52) U.S. Cl. 30/162; 30/312

(57) ABSTRACT

The present invention generally relates to a knife. In one aspect, a utility knife is provided. The utility knife includes a first handle and a second handle, wherein the handles are configured to be grasped by a hand of a user and slidable relative to each other between a retracted position, in which a leading edge of the second handle is disposed rearward of a leading edge of the first handle, and an extended position. The utility knife further includes a blade and a blade holder configured to hold the blade, wherein the blade holder is movable with the second handle between the extended and retracted positions. In another aspect, a method of operating a utility knife is provided.

### CROSS-REFERENCE TO RELATED APPLICATIONS

This application claims benefit of Chinese patent application serial number 200830220861.6, filed Nov. 29, 2008, which is herein incorporated by reference.

### BACKGROUND OF THE INVENTION

1. Field of the Invention

Embodiments of the present invention generally relate to a cutting knife. More particularly, embodiments of the present invention relate to a cutting knife that includes a first handle and a second handle that are slidable relative to each other.

2. Description of the Related Art

A conventional utility knife typically includes a handle and a blade. The blade in the conventional utility knife is movable relative to the handle between a retracted position and an extended position. In the retracted position, the blade is positioned within the handle and in the extended position, a portion of the blade extends from the handle. The handle in the conventional utility knife is typically made from a single piece or several pieces that are stationary relative to each other. Even though this handle arrangement may be an effective means to provide support for the user, there is still a need for an improved utility knife.

### SUMMARY OF THE INVENTION

The present invention generally relates to a knife. In one aspect, a utility knife is provided. The utility knife includes a first handle and a second handle, wherein the handles are configured to be grasped by a hand of a user and slidable relative to each other between a retracted position, in which a leading edge of the second handle is disposed rearward of a leading edge of the first handle, and an extended position. The utility knife further includes a blade and a blade holder configured to hold the blade, wherein the blade holder is movable with the second handle between the extended and retracted positions.

In another aspect, a method of operating a utility knife is provided. The method includes the step of providing the utility knife, wherein the utility knife including a blade, a blade holder, a first handle and a second handle. The method further includes the step of grasping the knife in a manner that utilizes the first and second handles. The method further includes the step sliding the handles relative to each other from a retracted position, wherein a leading edge of the second handle is rearward of a leading edge of the first handle, to move the blade from a retracted position to an extended position and thereby exposing the blade.

In yet another aspect, a utility knife is provided. The utility knife includes a first handle and a second handle, wherein the handles are each configured to be grasped by a hand of a user and slidable relative to each other between a retracted position and an extended position. The utility knife further includes a blade. Additionally, the utility knife includes a blade holder configured to hold the blade, wherein the blade holder is movable with the second handle between the extended and retracted positions, and wherein the blade holder is configured to selectively release the blade in the extended position.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a view illustrating a knife with a blade in a retracted position.

FIG. 2 is a view illustrating the knife with the blade in an extended position.

FIG. 3 is a view illustrating a top of the knife.

FIG. 4 is a view illustrating a bottom of the knife.

FIG. 5 is a view illustrating a front of the knife.

FIG. 6 is a view illustrating a side of the knife.

FIG. 7 is a view illustrating the knife with the blade in an intermediate position.

### DETAILED DESCRIPTION

The present invention generally relates to a cutting knife. To better understand the aspects of the present invention and the methods of use thereof, reference is hereafter made to the accompanying drawings.

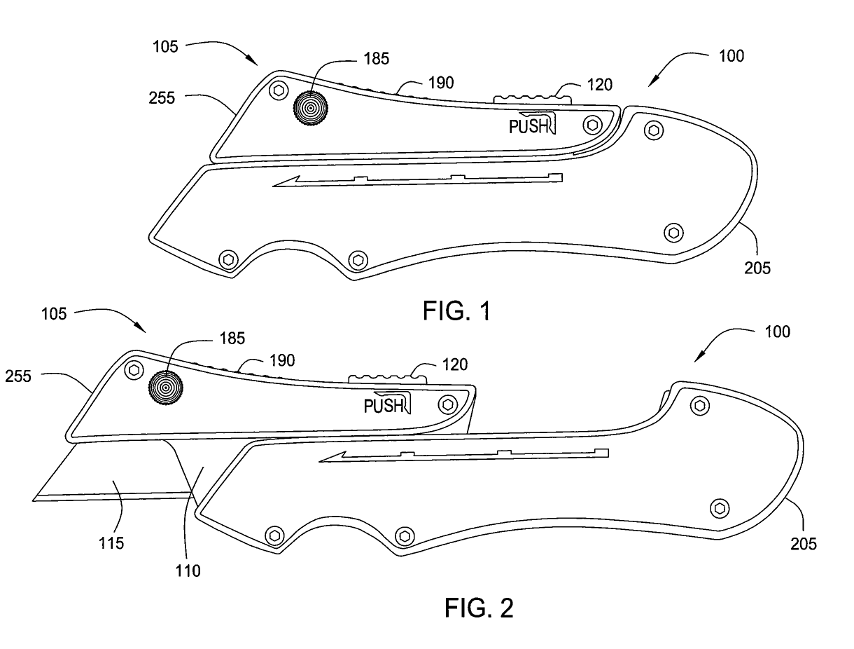

FIGS. 1 and 2 are views illustrating a knife 100 having a blade holder 110 in a retracted position and an extended position. The blade holder 110 is movable between the retracted and the extended position by manipulating a button 120 on an upper portion of the knife 100. In the extended position, the cutting edge of a blade 115 extends from a first handle 205 of the knife 100. In the retracted position, the cutting edge of the blade 115 is disposed within the first handle 205 of the knife 100.

The knife 100 includes the first handle 205 and a second handle 255. As shown in FIGS. 1 and 2, the first handle 205 and the second handle 255 are slidable relative to each other. In the retracted position shown in FIG. 1, the leading edge of the second handle 255 is disposed rearward of the leading edge of the first handle 205. In the extended position shown in FIG. 2, the leading edge of the second handle 255 is disposed forward of the leading edge of the first handle 205. The leading edge of the second handle 255 may be angled to substantially correspond to the leading edge of the blade 115. For example, the leading edge of the second handle 255 may be substantially parallel to the leading edge of the blade 115. Similarly, the leading edge of the first handle 205 may be angled to substantially correspond to the leading edge of the blade 115. For example, the leading edge of the first handle 205 may be substantially parallel to the leading edge of the blade 115. The leading edge of the first handle 205 and the leading edge of the second handle 255 may be complementary such that, for example, the leading edges of the first handle 205 and the second handle 255 form a substantially straight, angled surface along a front edge of the knife when the knife is in the retracted position.

The blade holder 110 is configured to hold a portion of the blade 115. Further, the blade holder 110 is configured to move the blade 115 relative to the first handle 205 as the blade holder 110 moves between the retracted position and the extended position. The blade holder 110 is connected to the button 120. Generally, the button 120 is used to move the blade holder 110 relative to the first handle 205. The button 120 is also used to lock the blade holder 110 in the retracted position and the extended position. In the embodiment illustrated, the blade holder 110 is movable with the second handle 255.

The blade holder 110 includes a blade lock assembly 105 that holds the blade 115 in the blade holder 110. The blade lock assembly 105 is movable between a lock position and a release position. In the lock position, the blade 115 is secured (or locked) to the blade holder 110. In the release position, the blade 115 may be removed from the blade holder 110 and subsequently replaced by another blade. In one embodiment, the blade 115 is a trapezoidal blade with a mounting notch formed on a first linear edge and a cutting edge on a second linear edge.

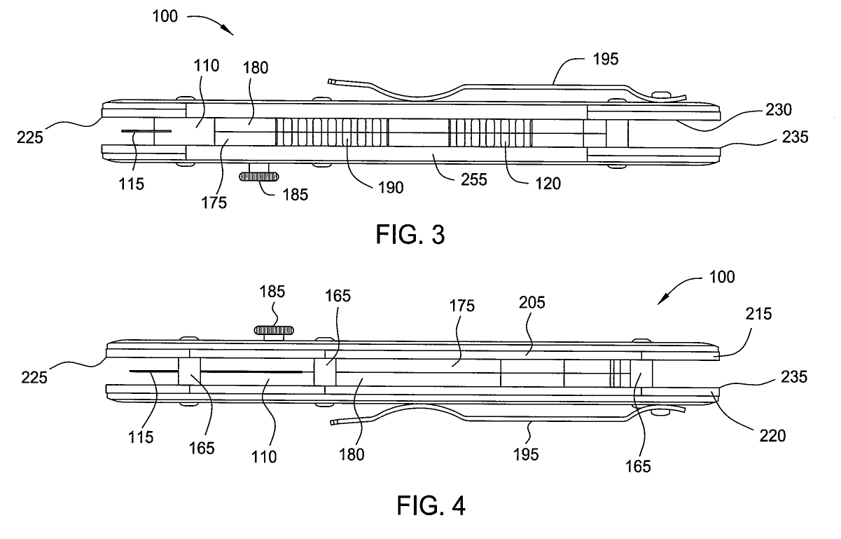

FIG. 3 is a view illustrating the top of the knife 100. The blade holder 110 includes a first side plate 180 and a second side plate 175. The plate 175 is attached to the plate 180 such that the blade holder 110 covers a portion of a first side and a second side of the blade 115. In one embodiment, the side plate 180 and the side plate 175 have different thicknesses. In this embodiment, the blade 115 is offset from a longitudinal axis of the first handle 205. As a result, the blade 115 may be spaced closer to one edge of a front slot (or aperture) 225 than another edge of the front slot (or aperture) 225. For instance, the blade 115 may be spaced from one edge of the slot (or aperture) 225 by less than 1 mm.

The blade holder 110 includes the blade lock assembly 105 that holds the blade 115 in the blade holder 110. The blade lock assembly 105 includes a biasing member (not shown) such as a leaf spring and a button member 185. As the button member 185 is pushed (or pulled), the blade lock assembly 105 moves between the lock position and the release position. The button member 185 is attached to the blade holder 110 and the button member 185 extends through a hole formed in the second handle 255.

The blade lock assembly 105 includes the biasing member. When the blade lock assembly 105 is in the lock position, the biasing member is engaged with a portion of the blade 115 such that the blade 115 is secured within the blade holder 110. In one embodiment, the biasing member includes a pin or boss (not shown) which is configured to engage with the mounting notch of the blade 115 when the blade lock assembly 105 is in the lock position. When the blade lock assembly 105 is in the release position, the biasing member is substantially disengaged with the blade 115 such that the blade 115 may be removed from the blade holder 110. It is to be noted that that blade lock assembly 105 is biased in the lock position. In other words, the biasing member is biased toward the blade 115 such that the biasing member engages the blade 115.

To move the blade lock assembly 105 from the lock position to the release position, the button member 185 is urged in a first direction, which causes the biasing member (and pin) to move away from the blade 115. At this point, the blade 115 may be removed from the blade holder 110 and subsequently replaced with another blade. After the blade is placed in the blade holder 110, the button member 185 is urged in a second direction, which causes the biasing member (and pin) to engage the blade 115. In one embodiment, the first direction is toward the blade 115 and the second direction is away from the blade 115. In another embodiment, the button member 185 is biased radially outward from the blade holder 110. As also shown in FIG. 3, the blade holder 110 includes a ribbed (or knurled edge) portion 190 which may be used to facilitate the gripping of the blade holder 110 by the user.

FIG. 4 is a view illustrating the bottom of the knife 100 with the blade holder 110 in the retracted position. As illustrated, the first handle 205 is formed from a first plate 215 and a second plate 220. The first plate 215 is separated from the second plate 220 by a plurality of spacer members 165. The first handle 205 includes the front slot 225, a top slot 230 (see FIG. 3), a rear slot 235 and a bottom slot 240. It is to be noted that each slot defines an opening or aperture in the first handle 205. In one embodiment, the blade 115 extends through the front slot 225 (or aperture) of the first handle 205 when the knife 100 is in the extended position. In another embodiment, the blade holder 110 and the blade 115 extend through the front slot 225 (or aperture) of the first handle 205 when the knife 100 is in the extended position. The blade holder 110 extends through the top slot 230 (or aperture) of the first handle 205 and the blade holder 110 slides along the top slot 230 as the blade holder 110 moves between the retracted and extended position. In other words, a portion of the blade holder 110 is disposed outside the first handle 205 in the extended position and the retracted position. In a similar manner, the blade 115 extends through the top slot 230 of the first handle 205. Therefore, a first part of the blade 115 is disposed in the first handle 205 and a second part of the blade 115 is disposed in the second handle 255.

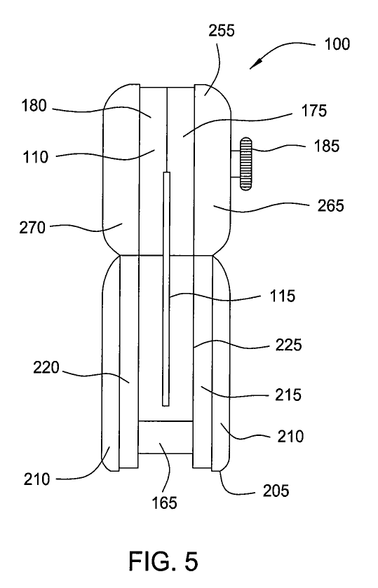

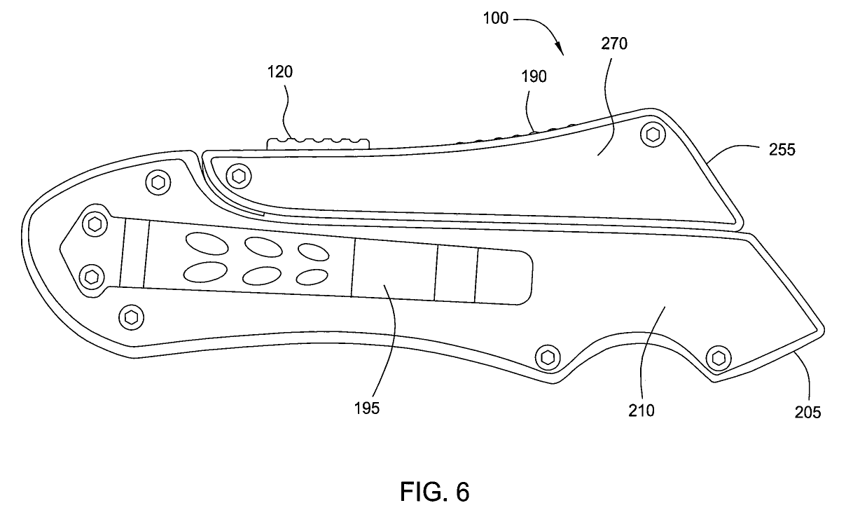

FIG. 5 is a view illustrating the front of the knife 100. As shown, a cover plate 210 is attached to the plates 215, 220 of the first handle 205. As also shown, the second handle 255 includes a first plate 265 and a second plate 270 on each side of the blade holder 110 by a plurality of connection members. In this configuration, the blade holder 110 and the second handle 255 move together relative to the first handle 205. FIG. 6 is a view illustrating a side of the knife 100. As shown, there is also provided an optional spring clip 195 secured to the cover 210.

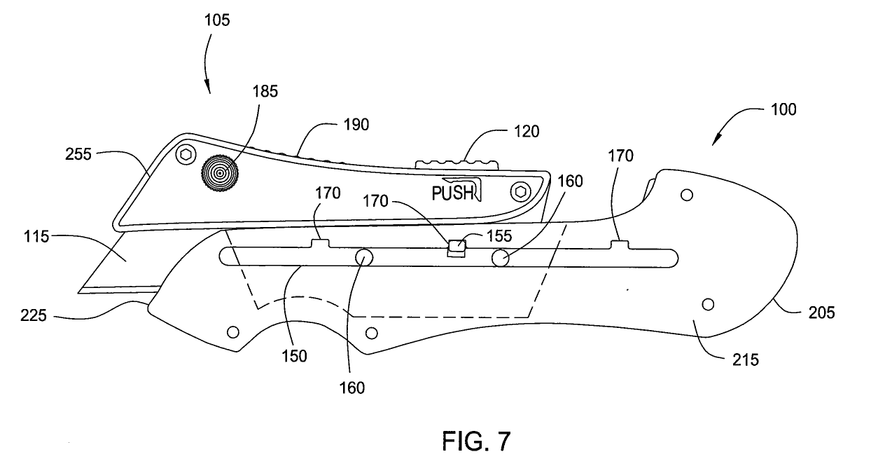

FIG. 7 is a view illustrating the knife with the blade in an intermediate position. For clarity, the cover 210 has been removed. As illustrated, the plate 215 includes a slot 150 having a plurality of detents 170. The plate 220 includes a corresponding slot with detents (not shown). The slot 150 is configured to interact with pin members 160 on the blade holder 110 as the knife 100 moves between the extended position and the retracted position. The detents 170 are configured to interact with a bar 155 (or pin) that is attached to the button 120 in order to lock the blade holder 110 in the predetermined position, such as the retracted position (FIG. 1), the intermediate position (FIG. 7) and the extended position (FIG. 2). Although the knife in FIG. 7 shows three detents 170 (e.g. lock positions), any number of detents may be used without departing from principles of the present invention. Further, is to be noted that the button 120 is biased away from the second handle 255 by a biasing member (not shown), such as a spring.

The blade holder 110 is movable between a locked position and an unlocked position. In the locked position, the bar 155 is engaged in one of the detents 170 such that the blade holder 110 cannot slide along the slot 150. In the unlocked position, the bar 155 is disengaged from the detent 170 and positioned within the slot 150 which allows the blade holder 110 to slide along the slot 150. It is to be noted that the bar 155 is connected to the button 120 and therefore the biasing member attached to the button 120 also biases the bar 155 into engagement with the detent 170. Therefore, as the blade holder 110, the bar 155 and the pins 160 move along the slot 150, the upwardly biased bar 155 will be urged into the next detent 170 along the slot 150.

The blade holder 110 is moved to the intermediate position, as shown, by applying a force to the button 120 that causes the button 120 to move in a direction toward the second handle 255. This movement of the button 120 compresses the biasing member and moves the bar 155 out of the detent 170 and into the slot 150. With the bar 155 in the slot 150, the blade holder 110 is allowed to move relative to the first handle 205 until the bar 155 engages the next detent 170. At that time, the blade holder 110 is moved to the locked position as shown in FIG. 7.

The design of the knife 100 permits it to be operated with one hand wherein the fingers of the hand are in contact with the first handle 205 and the thumb of the hand is in contact with the second handle 255. In operation, the knife 100 is moved from the retracted position to a desired position, such as the intermediate position or the extended position by applying a force to the button 120. For example, the force may be applied to the button 120 with the thumb on the hand grasping the knife 100. The force on the button 120 causes the bar 155 to move out of the detent 170 and into the slot 150. At this point, the second handle 255 can be moved relative to the first handle 205 until the knife 100 is in the desired position. In this manner, the length of the knife 100 is elongated (see FIGS. 1-2). The knife 100 can be locked in the desired position by allowing the bar 155 to move back into the detent 170 at the desired position.

While the foregoing is directed to embodiments of the present invention, other and further embodiments of the invention may be devised without departing from the basic scope thereof, and the scope thereof is determined by the claims that follow.

1. A utility knife comprising:
a first handle and a second handle, the handles each configured to be grasped by a hand of a user and slidable relative to each other between a retracted position, in which a leading edge of the second handle is disposed rearward of a leading edge of the first handle, and an extended position;
a blade; and
a blade holder configured to hold the blade, wherein the blade holder is movable with the second handle between the extended and retracted positions.

2. The utility knife of claim 1, wherein in the extended position, the leading edge of the second handle is disposed forward of the leading edge of the first handle.

3. The utility knife of claim 2, wherein the blade is a trapezoidal utility blade.

4. The utility knife of claim 3, wherein the second handle has an angled leading edge substantially corresponding to a leading edge of the blade.

5. The utility knife of claim 4, wherein the first handle has an angled leading edge substantially corresponding to the leading edge of the blade.

6. The utility knife of claim 5, wherein the angled leading edges of the first and second handles are complementary and form a substantially straight, angled surface along a front edge of the knife when the knife is in the retracted position.

7. The utility knife of claim 1, wherein a cutting edge of the blade is housed completely within the first handle and an upper mounting edge of the blade is housed within the second handle in the retracted position.

8. The utility knife of claim 1, wherein the first handle includes an aperture formed at its front edge, the aperture configured to permit the blade to extend and retract relative to the first handle.

9. The utility knife of claim 1, wherein the blade holder is configured to selectively release the blade when the utility knife is in the extended position.

10. A method of operating a utility knife, the method comprising:
providing the utility knife, wherein the utility knife including a blade, a blade holder, a first handle and a second handle;
grasping the knife in a manner that utilizes the first and second handles; and
sliding the handles relative to each other from a retracted position, wherein a leading edge of the second handle is rearward of a leading edge of the first handle, to move the blade from a retracted position to an extended position and thereby exposing the blade.

11. The method of claim 10, further comprising sliding the handles relative to each other to move the blade from the extended position to the retracted position, wherein the blade is not exposed in the retracted position.

12. The method of claim 10, wherein a portion of the blade holder is housed in the second handle and sliding the handles relative to each other from the retracted position to the extended position further comprises moving the blade holder with the second handle.

13. The method of claim 10, further comprising replacing the blade when the utility knife is in the extended position.

14. A utility knife comprising:
a first handle and a second handle, the handles each configured to be grasped by a hand of a user and slidable relative to each other between a retracted position and an extended position,
a blade; and
a blade holder configured to hold the blade, wherein the blade holder is movable with the second handle between the extended and retracted positions, and wherein the blade holder is configured to selectively release the blade in the extended position.

15. The utility knife of claim 14, wherein a leading edge of the second handle is disposed rearward of a leading edge of the first handle in the retracted position.

16. The utility knife of claim 15, wherein the first handle and second handle are configured to be slidable relative to each other to an intermediate position which is between the retracted position and the extended position, and wherein the leading edge of the second handle is disposed forward of the leading edge of the first handle in the intermediate position.

17. The utility knife of claim 14, wherein the first handle includes an aperture formed at its front edge, the aperture configured to permit the blade to extend and retract relative to the first handle.

18. The utility knife of claim 14, wherein the blade holder comprises a biasing member configured to selectively engage a mounting notch in the blade, the biasing member biased toward the mounting notch.

19. The utility knife of claim 18, wherein the blade holder is configured to selectively release the blade in the extended position when a force urges the biasing member out of the mounting notch.

20. The utility knife of claim 14, wherein a cutting edge of the blade is housed completely within the first handle and an upper mounting edge of the blade is housed within the second handle in the retracted position.
